(19) United States
(12) Patent Application Publication
(10) Pub. No.: US 2026/0365198 A1
(43) Pub. Date: Nov. 19, 2026

(54) DOMAIN ADAPTATION FOR END-TO-END AUTONOMOUS DRIVING

(71) Applicant: QUALCOMM Incorporated, San Diego, CA (US)

(72) Inventors: Rajeev YASARLA, San Diego, CA (US); Hong CAI, San Diego, CA (US); Shizhong Steve HAN, San Diego, CA (US); Apratim BHATTACHARYYA, San Diego, CA (US); Shweta MAHAJAN, San Diego, CA (US); Litian LIU, San Diego, CA (US); Risheek GARREPALLI, San Diego, CA (US); Yunxiao SHI, San Diego, CA (US); Hsin-Pai CHENG, San Diego, CA (US); Fatih Murat PORIKLI, San Diego, CA (US)

(21) Appl. No.: 19/222,747

(22) Filed: May 29, 2025

Related U.S. Application Data
(60) Provisional application No. 63/806,190, filed on May 15, 2025.

(51) Int. Cl. B60W 60/00

(52) U.S. Cl. CPC B60W 60/001

(57) ABSTRACT

Aspects relate generally to end-to-end autonomous driving. Disclosed is an apparatus for a vehicle useable in autonomous driving comprising: one or more memories configured to store one or more images and one or more processors coupled to the one or memories. The one or more processors are configured to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle.

### CROSS-REFERENCE TO RELATED APPLICATIONS

The application claims priority to and the benefit of U.S. provisional patent application No. 63/806,190 filed on May 15, 2025, the entire content of which is incorporated herein by reference as if fully set forth below in its entirety and for all applicable purposes.

### TECHNICAL FIELD

The technology discussed below relates generally to autonomous driving, and more particularly, to domain adaptation for end-to-end autonomous driving.

### INTRODUCTION

Autonomous motor vehicles, such as cars, trucks, trains, etc., are vehicles that have the ability to sense their own environment, and take one or more actions based on the sensing. For example, an autonomous vehicle's sensing can generate a model of its surrounding environment, including other vehicles, pedestrians, roadways, traffic signals, as well as other surrounding elements. Then based on identification of objects, relative positions, relative motions, and a planned travel route, the autonomous vehicle can slow down based on another vehicle's speed, stop at a red light, turn at an upcoming intersection, as well as take other actions.

Prevention and mitigation of traffic accidents with other vehicles, whether those other vehicles are fully autonomous, semi-autonomous, or legacy vehicles (e.g., controlled solely through human input), is a vital aspect of autonomous driving. However, due to the mixture of legacy cars and autonomous cars at different levels of driving capability, the complexity of traffic safety problems is expected to be exponentially increasing as it becomes more difficult to predict how cars with mixed levels of autonomous support will respond to the actions of other cars.

One type of autonomous driving system for autonomous vehicles is an End-to-End (E2E) autonomous driving system. E2E autonomous driving systems can be used to directly map raw sensor data to vehicle control actions. E2E autonomous driving systems can be implemented using deep learning and can combine perception, prediction, and planning. E2E autonomous driving systems offer significant potential but face critical challenges in generalizing across diverse domains (e.g., cities, weather, etc.) and robustly handling infrequent long-tail scenarios, often due to dataset limitations and training imbalances. While Large Language Models (LLMs) show promise, they introduce prohibitive retraining costs and do not inherently guarantee cross-domain generalization or solve the data imbalance issue.

Moving beyond the traditional paradigm of modular designs, where distinct components like perception, motion, prediction and planning are often developed and optimized in isolation, the focus in contemporary autonomous driving research has shifted towards integrated E2E multi-task systems. This evolution is driven by the significant potential these approaches offer for enhanced overall driving performance, potentially improved interpretability, and greater computational efficiency. However, despite these compelling advantages, a significant hurdle persists: these sophisticated E2E systems frequently demonstrate brittleness or a lack of robustness when encountering infrequent yet critical ‘long-tail’ scenarios. This fragility is often linked to the inherent limitations in the diversity of the large-scale datasets commonly employed for training, which may not adequately capture the full spectrum of rare events. Compounding this challenge, current E2E models often struggle significantly with domain generalization, finding it difficult to adapt effectively for safe motion planning across diverse operational domains-such as different cities—with unique traffic patterns, varying weather conditions, or changing lighting situations—without requiring specific, often extensive, retraining. Furthermore, the standard training process itself can inadvertently exacerbate the issue with long-tail events. Current datasets are dominated by simple, high-frequency scenarios, causing optimization algorithms to naturally prioritize performance on these common cases and consequently under-weight the crucial, albeit less frequent, long-tail situations, potentially hindering the models ability to handle them safely in the real world.

Large language models (LLMs) have recently emerged as a potentially powerful avenue to address these persistent challenges, leveraging their extensive world knowledge gleaned from vast internet scale data to potentially generalize more effectively to unseen or rare scenarios. Multi-modal variants (MLLMs) further enhance this by integrating visual inputs, enabling a new wave of E2E driving systems that aim for higher interpretability and improved long-tail robustness. However, this integration introduces its own set of significant obstacles. There is no inherent guarantee that these LLM-infused models will seamlessly generalize across disparate domains without further adaptation. Moreover, retraining these massive models for new domains or updates is often prohibitively expensive and time-consuming, demanding enormous quantities of specialized instruction-following data. Critically, even with broad world knowledge, the fundamental issue of data imbalance may persist, potentially limiting their reliability in safety-critical long-tail situations.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for a vehicle useable in autonomous driving is provided. The apparatus may include one or more memories configured to store one or more images and one or more processors coupled to the one or memories. The one or more processors are configured to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle.

In another example, an apparatus for a vehicle useable in autonomous driving is disclosed. The apparatus may include one or more memories configured to store one or more images and one or more processors coupled to the one or memories. The one or more processors are configured to: receive input sensor data including images during end-to-end autonomous driving; and continuously update a scene codebook based upon the received input sensor data including images to identify trajectories for one or more scenarios.

In yet another example, a non-transitory computer-readable data storage medium is provided that has stored thereon instructions that, when executed, cause one or more processors to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

FIG. 1 is a block diagram of an autonomous vehicle performing autonomous driving according to some aspects.

FIG. 2 is block diagram of an autonomous vehicle according to some aspects.

FIG. 3A is a diagram to illustrate the off-line development of the components of the adaptation module based on source data according to some aspects.

FIG. 3B is a diagram to illustrate a predicted trajectory for an on-line implementation based on target data according to some aspects.

FIG. 4 is a diagram illustrating camera image input from a vehicle that are utilized by a scene tokenizer to represent objects, regions, or other relevant features in a scene according to some aspects.

FIG. 5 shows multiple tables illustrating test results for the RoCA system according to some aspects.

FIG. 6 is a flowchart of a method to implement autonomous driving by a vehicle according to some aspects.

FIG. 7 is a simplified diagram of circuitry to implement previously described processes according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure generally relate to an apparatus for a vehicle useable in end-to-end autonomous driving. The apparatus may comprise: one or more memories configured to store one or more images; and one or more processors coupled to the one or memories. The one or more processors are configured to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle. As will be described, in one embodiment, the neural trajectory planner may utilize a probabilistic Bayesian model, in which, the probabilistic Bayesian model utilizes a Gaussian process (GP). In one example, as will be described, the probabilistic Bayesian model of the neural trajectory planner determines a correlation between the current scenario of the vehicle and a set of learned scene features of the scene codebook to predict the trajectory for the vehicle.

In particular, to address the problems previously described with current E2E autonomous driving systems, aspects of the disclosure relate to a robust cross-domain end-to-end autonomous driving (RoCA). In the RoCA system, an E2E framework using multi-view images is utilized. In one embodiment, as will be described, the RoCA system learns a compact scene codebook of representative ego and agent token embeddings spanning diverse driving conditions. In one embodiment, a Gaussian Process (GP) framework of a probabilistic Bayesian model, conditioned on this codebook, is utilized to probabilistically predict future trajectories. In particular, the GP's predicted variance provides uncertainty estimation, enabling an adaptive loss weighting scheme that prioritizes challenging long-tail scenarios during training. This approach enhances both domain generalization and long-tail robustness without relying on massive pre-trained models. The RoCA system, reduces L2 trajectory error (e.g., the difference between a predicted trajectory and an actual or desired trajectory), collision rate, and long-tail trajectory error compared to vision-based baselines, achieving state-of-the-art performance on planning benchmarks (e.g., the nuScenes planning benchmark) and supports versatile adaptation settings.

Aspects of the disclosure related to the RoCA system are useful in reacting to ‘long-tail’ scenarios related to rare, unexpected, and complex driving situations that are difficult for autonomous vehicles to react to. Such long-tail scenarios may relate to scenarios including snow, rain, fog, night, etc. Other long-tail scenarios may include pedestrians and animals crossing the street, fallen rocks and trees in the street, broken down vehicles, etc. The RoCA system to be hereafter described has the capability to efficiently react to these different types of long-tail scenarios in different cities.

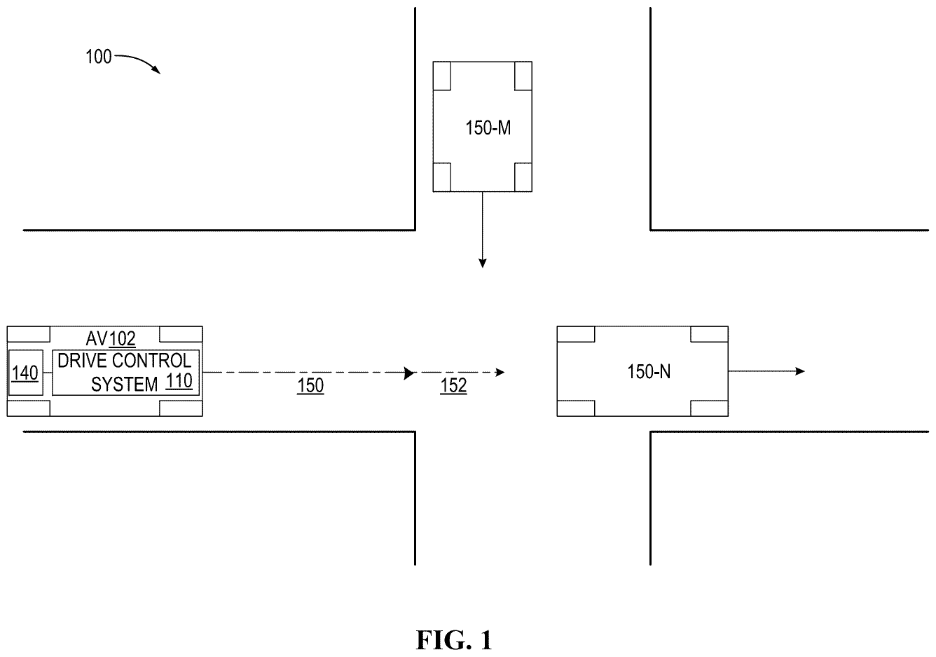

With reference to FIG. 1, FIG. 1 is a block diagram 100 of an autonomous vehicle performing autonomous driving. Safe autonomous driving is enabled based on one or more of relative positioning determinations, vehicle-to-vehicle communications, behavior modeling, as well as other factors discussed in greater detail herein.

In one embodiment, an autonomous vehicle 102, such as an autonomous car, truck, bus, etc. includes a drive control system 110. In one embodiment, the drive control system 110 is a computer processing system, which may include one or more processors, memory, I/O controllers, network interfaces, communication subsystems, modems, displays, etc., as discussed in greater detail herein. Furthermore, drive control system 110 interfaces with propulsion, steering control, braking, and other systems of the autonomous vehicle, in order to control one or more movements of the motor vehicle.

In embodiments, the drive control system 110 controls the various autonomous vehicle systems, such as braking, steering, adjusting speed, etc., to implement a driving plan. A driving plan can be utilized that include such factors as destination, route, waypoints, etc. that are used by the drive control system 110 to operate and navigate the autonomous vehicle 102 from an initial location to a destination. In embodiments, the driving plan may be altered by the drive control system 110 based on observations of one or more vehicles (e.g., vehicle 150-M, vehicle 150-N, as well as other vehicles not illustrated) in proximity to the autonomous vehicle 102.

In one embodiment, drive control system 110 utilizes one or more sensors 140 of the autonomous vehicles 102, such as RADAR, LIDAR, global positioning system (GPS) data, radio ranging, one or more cameras, etc. to sense nearby vehicles over a period of time. In embodiments, the observations of the nearby vehicles enable drive control system 110 to classify the vehicles, including identifying vehicles as fully autonomous vehicles, partially autonomous vehicles, or legacy vehicles (e.g., containing no autonomous and/or driver assist systems). Based on the classifications, relative positions, and relative movements, drive control system 110 updates the drive plan and takes one or more actions. For example, autonomous vehicle 102 may be operating based on a drive plan by controlling the vehicle at a certain rate of speed along a certain route, as indicated by dashed line 150. Vehicles 150-M and 150-N are sensed within a certain threshold proximity to autonomous vehicle 102, and various observable vehicle characteristics are gathered by the sensors 140 (e.g., relative positions, relative velocities, relative accelerations, relative direction of movement, color of the vehicle, make and model of the vehicles, etc.). In one embodiment, drive control system 110 utilizes the observations to generate observable vehicle characteristics of the surrounding vehicles. In one embodiment, vehicles may also communicate directly with one another utilizing vehicle-to-vehicle (V2V) communications that transmit autonomous driving vehicle characteristics (e.g., partial, fully, or disabled autonomous driving, autonomous driving strategy as safe, sport, etc.), as well as other vehicle and/or driver characteristics.

In one embodiment, drive control system 110 utilizes a trained machine learning model that analyzes the observed vehicle characteristics (e.g., relative motion, relative direction, relative accelerations, visual vehicle characteristics, visual driver characteristics, exchanged V2V information, etc.) to classify behavioral driving characteristics of each observed vehicle. The trained machine learning model analysis enables drive control system 110 to determine whether nearby vehicles are at least partially autonomous, generate predicted behavioral driving characteristics of the vehicles (e.g., safe, aggressive, reckless, unpredictable, etc. classifications), as well as classifications of other behavioral driving characteristics for each observed vehicle.

Drive control system 110 can update the drive control plan of autonomous vehicle 102. For example, based on observations and/or V2V data exchange with vehicles 150-M and 150-N, drive control system 110 may determine that vehicle 150-M is a fully autonomous vehicle operating using a ‘safe’ driving strategy and operating as expected (e.g., based on such factors as observed relative speed, observed relative deceleration with respect to intersection 170, exchanged V2V information, maintaining constant speed and direction, etc.). However, drive control system 110 may determine that vehicle 150-N is a legacy vehicle based on irregular relative accelerations, lack of V2V data exchange, observed make and model of car, etc. Based on both sets of observations, drive control system 110 may then determine not to update its drive plan based on vehicle 150-M's observed behavioral driving characteristics, as vehicle 150-M is predicted to operate in a predictable and safe manner. Drive control system 110, may update its drive plan relative to irregular behavioral driving characteristics of vehicle 150-N, causing autonomous vehicle 102 to slow down, increase a distance between autonomous vehicle 102 and vehicle 150-N, activate an emergency system (e.g., collision warning, brake support, etc.), with the updated drive plan indicated by dashed line 152.

In embodiments, drive control system 110 performs sensing of its surrounding environment on a periodic basis, such as every 1/60^{th} of a second, every 1/10^{th} of a second, etc., performs observations of surrounding vehicles, updates its drive plan, and takes actions according to the updated drive plan. In one embodiment, the periodic nature of the observations, surrounding vehicle characterizations, drive plan updates and implementation, enables autonomous vehicle 102 to operate in a safe and autonomous manner and continuously adjust and react to its environment.

In one embodiment, autonomous vehicle 102 transmits the sensor based observations of the surrounding vehicles (e.g., visual vehicle characteristics, motion based vehicle characteristics, V2V exchanged characteristics, etc.) to an assistance data server (not shown). In embodiments, the reports are periodic (e.g., once per day, once per hour, at the end of each trip of autonomous vehicle 102, etc.).

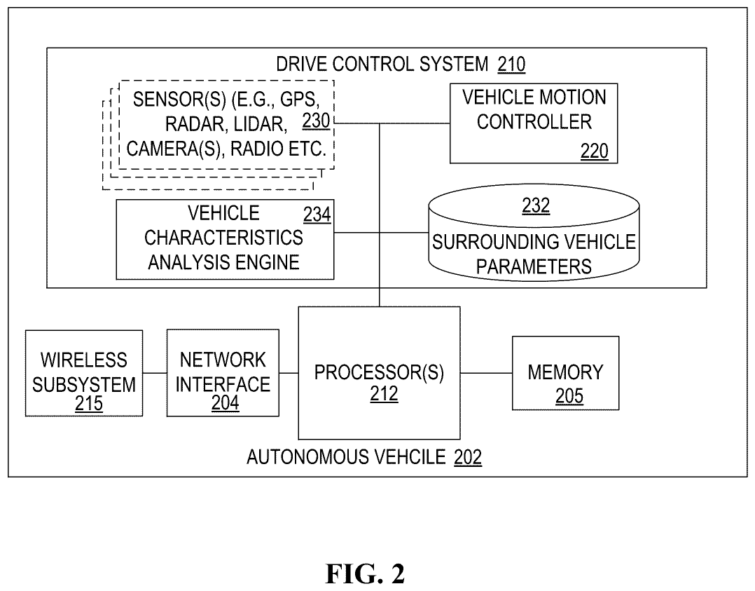

FIG. 2 is block diagram of an autonomous vehicle. Autonomous vehicle 202 provides additional details for autonomous vehicle 102 discussed above in FIG. 1. In one embodiment, autonomous vehicle 202 is a system, which may include one or more processor(s) 212, a memory 205, a network interface 204, and a wireless subsystem 215. It should be appreciated that autonomous vehicle 202 may also include, although not illustrated, a user and/or hardware interface, one or more power device(s) (e.g., vehicle battery, drive control system 210 battery, etc.), a propulsion system (e.g. an electric, gasoline, etc. powered motor), a steering system, a braking system, as well as other components typically associated with motor vehicles. Although only a single wireless subsystem 215 is illustrated, it is understood that network interface 204 (e.g., modem, transceiver, etc.) may be capable of communicatively coupling autonomous vehicle 202 to any number of wireless subsystems (e.g., Bluetooth, WiFi, Cellular, or other networks) to transmit and receive data streams through a wireless link to/from a network. Wireless subsystem may enable communication with an assistance data server (not shown).

In embodiments, memory(s) 205 of autonomous vehicle 202 may be coupled to processor(s) 212 to store instructions for execution by the processor(s) 212. In some embodiments, the memory is non-transitory, and may store one or more processing modules. In one embodiment, memory 205 of autonomous vehicle 202 may store one or more processing modules of drive control system 210, such as surrounding vehicle characteristics engine 250, vehicle motion controller 270, interfaces to one or more sensor(s) 240 (e.g., GPS, RADAR, LIDAR, radio, camera(s), and other vehicle sensors), and a surrounding vehicle parameters 260 data store.

It should be appreciated that the embodiments as will be hereinafter described may be implemented through the execution of instructions, for example as stored in memory or other element, by processor(s) and/or other circuitry of autonomous vehicle 202. Particularly, circuitry of autonomous vehicle 202, including but not limited to processor(s) 212 may operate under the control of a program, routine, or the execution of instructions to execute methods or processes in accordance with the aspects and features described herein. For example, such a program may be implemented in firmware or software (e.g. stored in memory 205) and may be implemented by processors, such as processor(s) 212, and/or other circuitry. Further, it should be appreciated that the terms processor, microprocessor, circuitry, controller, etc., may refer to any type of logic or circuitry capable of executing logic, commands, instructions, software, firmware, functionality and the like.

Furthermore, it should be appreciated that some or all of the functions, engines, or modules described herein may be performed by autonomous vehicle 202 itself and/or some or all of the functions, engines or modules described herein may be performed by another d through network interface 204 to autonomous vehicle 202. Thus, some and/or all of the functions may be performed by another system, and the results or intermediate calculations may be transferred back to autonomous vehicle 202.

In one embodiment, autonomous vehicle 202 includes drive control system 210, which performs fully autonomous, partially autonomous, or legacy operations based on input of a user. Legacy control of autonomous vehicle 202 can include a driver manually controlling a steering wheel, depressing an accelerator, depressing a brake, activating a traction control system, etc. Vehicle motion controller 220 responds to one or more of the driver inputs to control various vehicle operation systems (not shown) of autonomous vehicle, such as an engine, brakes, steering controls, etc. of autonomous vehicle.

Vehicle motion controller 220 of drive control system 210 may utilize a drive plan to control the one or more of the vehicle operation systems without the intervention of a user (e.g., full or partial autonomous vehicle control). A drive plan can include a destination, waypoints, etc. that enable vehicle motion controller 220 to autonomously or partially autonomously navigate autonomous vehicle 202 according to the drive plan. The autonomous and partially autonomous operation of autonomous vehicle 202 by vehicle motion controller 220 dynamically adapts to surrounding environmental factors, including neighboring vehicles (e.g., vehicles 150-M and 150-N illustrated in FIG. 1), roadway conditions, obstacles, etc., using a trained machine learning model.

As will be discussed in greater detail below, a trained machine learning model is generated using sensor based observations of observable vehicle characteristics, as well as vehicle-to-vehicle (V2V) communications indicating vehicle driving characteristics. For example, autonomous vehicle 202 may capture a plurality of sensor based observations of vehicles that it encounters during a trip. In embodiments, sensors 230 of autonomous vehicle 202 can include various sensors including, but not limited to, global positioning system (GPS) sensors, RADAR sensors, LIDAR sensors, one or more cameras, a visual depth mapping system, radio receivers for performing radio ranging, etc. In embodiments, the sensor collected sensor data may be stored in surrounding vehicle parameters database 232. The sensor data collected by sensors 230 and stored in surrounding vehicle parameters database 232 are a rich collection of the observable characteristics of vehicles encountered by autonomous vehicle 202, such as relative positioning, relative speeds, relative accelerations, vehicle path tracking information (e.g., maintaining driving lane, ability to maintain regular path, irregular path, etc.). Vehicle characteristics analysis engine 234 can include one or more machine learning models for preprocessing and/or analyzing the sensor data. For example, in addition to the trained machine learning drive plan model, vehicle characteristics analysis engine 234 may also include visual analysis models for performing one or image processing operations based on captured sensor image data, such as image matching to determine vehicle make and model of an observed neighboring vehicle, to distinguish a neighboring vehicle as a car, truck, motorcycle, bicycle, etc., to extract driver information such as driver identity, driver age, etc. Furthermore, in embodiments, the collected sensor data can include information exchanged via vehicle-to-vehicle communication, such as exchanged make, model, vehicle motion controller software version, whether a vehicle is currently being operated in a legacy, partial, or fully autonomous mode, etc.

It should be appreciated that previous description of autonomous vehicle 202 is just an example of a type of autonomous vehicle, and that other types of autonomous vehicle may be utilized to implement aspects described hereafter. Further, autonomous vehicle 202 may be in communication with an assistance data server (not show) via a wireless subsystem 215 to implement aspects described hereafter.

In one aspect of the disclosure as will be described, an apparatus for a vehicle useable in end-to-end autonomous driving is disclosed. The apparatus may comprise: one or more memories configured to store one or more images; and one or more processors coupled to the one or memories. The one or more processors are configured to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle. As will be described, in one embodiment, the neural trajectory planner may utilize a probabilistic Bayesian model, in which, the probabilistic Bayesian model utilizes a Gaussian process (GP). In one example, as will be described, the probabilistic Bayesian model of the neural trajectory planner determines a correlation between the current scenario of the vehicle and a set of learned scene features of the scene codebook to predict the trajectory for the vehicle.

In order to implement these techniques, as will be described, a scene code book is learned using vector quantization techniques utilizing Bayesian techniques (e.g., a Gaussian process (GP)). This enables the learning of the basis vectors for the scene code book that represent scenario embeddings of the ego vehicle and their function mapping to a trajectory. Formulating this probabilistic or Bayesian model using Gaussian process (GP) and vector quantization, allows powerful function mapping from ego-embedding and agent embedding to ego-trajectory and ego-action. Unlike previous implementations (e.g., LLMs), the GP model trajectory output is more informative in terms of confidence of the prediction. Furthermore, the GP model can act as a better teacher (e.g., than LLMs) and can improve planning network performance while adapting to new scenarios or cities without any additional ground-truth or human annotations. Additionally, the GP model can identify out-of-distribution scenarios and the user can formulate an active-learning setting to adapt to these out-of-distribution samples

As has been described, to enhance current E2E autonomous driving systems and to address problems associated with current E2E autonomous driving systems, aspects of the disclosure relate to a robust cross-domain end-to-end autonomous driving (RoCA) system. In the RoCA system, an E2E framework using multi-view images is utilized. In one embodiment, as will be described, the RoCA system learns a compact scene codebook of representative ego and agent token embeddings spanning diverse driving conditions. In one embodiment, a Gaussian Process (GP) framework of a probabilistic Bayesian model, conditioned on this codebook, is utilized to probabilistically predict future trajectories. In particular, the GP's predicted variance provides uncertainty estimation, enabling an adaptive loss weighting scheme that prioritizes challenging long-tail scenarios during training. This approach enhances both domain generalization and long-tail robustness without relying on massive pre-trained models. The RoCA system, reduces L2 trajectory error, collision rate, and long-tail trajectory error compared to vision-based baselines, achieving state-of-the-art performance on planning benchmarks (e.g., the nuScenes planning benchmark) and supports versatile adaptation settings. L2 trajectory error or L2 loss may refer to Mean Squared Error (MSE) and measures the difference between a predicted trajectory and an actual or desired trajectory and may be calculated as the average of the squared differences between the two trajectories at corresponding points in time.

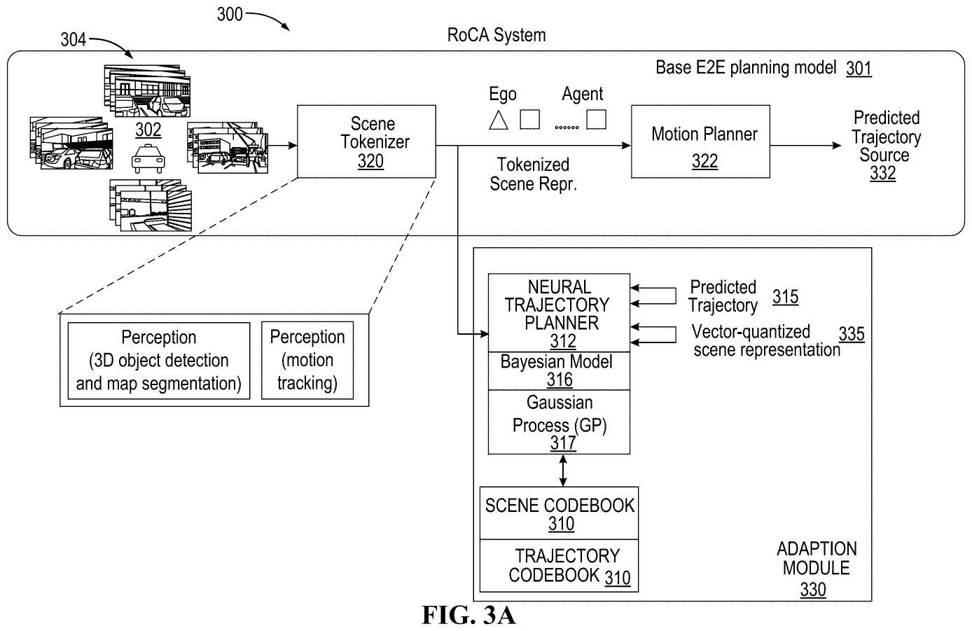

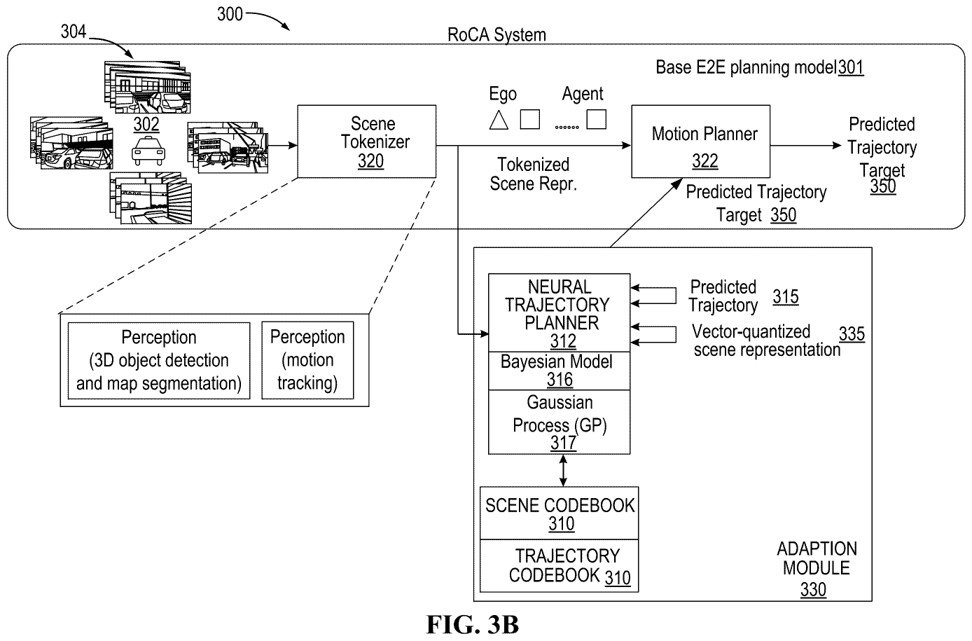

With additional reference to FIG. 3A, a diagram showing components of the robust cross-domain end-to-end autonomous driving (RoCA) system 300 according to one aspect will be described. As shown in FIG. 3A, a RoCA system 300 is implemented for a vehicle 302 useable in end-to-end autonomous driving. The RoCA system 300 may include a plurality one or more memories (e.g., memories 205, previously described) configured to store one or more images 304. Further, the RoCA system 300 may include one or more processors (e.g., processor(s) 212), previously described coupled to the one or memories, to implement the operations to be hereafter described. As will be described, FIG. 3A is utilized to illustrate the off-line development of the components of the adaptation module 330 (neural trajectory planner 312, Bayesian model 316, Gaussian Process 317, scene codebook 310, trajectory codebook 311) based on source data from a source city.

FIG. 3B will be utilized to describe on-line implementation for a target city, such that predicted trajectories for on-line implementation for the target city are based on the developed adaptation module 330 from the off-line development based on source data from a source city (FIG. 3A). Therefore, as will be described with reference to FIG. 3B, processor(s) (e.g., processor(s) 212) of the vehicle 302 may be configured to: obtain a scene codebook 310 to identify trajectories for one or more scenarios; and implement a neural trajectory planner 312 to predict a trajectory 350 for the vehicle 302 conditioned on a current scenario of the vehicle 302 based on the scene codebook 310 to implement autonomous driving of the vehicle. As will be described, in one embodiment, the neural trajectory planner 312 may utilize a probabilistic Bayesian model 316, in which, the probabilistic Bayesian model 316 utilizes a Gaussian process (GP) 317. In one example embodiment, as will be described, the probabilistic Bayesian model 316 of the neural trajectory planner 312 determines a correlation between the current scenario of the vehicle 302 and a set of learned scene features of the scene codebook 310 to predict the trajectory 350 for the vehicle 302.

With reference again to FIG. 3A, FIG. 3A is utilized to illustrate the off-line development of the components of the adaptation module 330 (neural trajectory planner 312, Bayesian model 316, Gaussian Process 317, scene codebook 310, trajectory codebook 311) based on source data from the source city. In one aspect, a base E2E planning model 301 is used by the RoCA system 300 and can be any existing E2E planning network 301, as long as it provides scene representation. For example, a scene tokenizer 320 may be utilized. Scene tokenizer 320 may be utilized to transform sensory inputs (e.g., from previous described sensor 230), such as, image inputs 304, from cameras into a structured interpretable representation that are composed of “tokens” that represent objects, regions, or other relevant features in the scene. These tokens (e.g., ego tokens and agent tokens) operate as an input to subsequent stages of the RoCA system 300, enabling the RoCA system 300 to comprehend and predict the driving environment for vehicle 302, as will be described. As an example, scene tokenizer 320 may utilize convolutional neural network (CNN), to extract relevant features from the input data and the extracted tokens can be utilized to create tokens (e.g., ego tokens and agent tokens) that represent different aspects of the scene. These tokens may include tokens related to: agent tokens-other cars, pedestrians, traffic lights, road segments, lane markings, or pedestrian crossings, etc.; map-aware tokens-integrating map information into the tokens to provide contextual understanding of the environment; and ego-tokens of the vehicle 302 itself (location, velocity, etc.). As shown, scene tokenizer 320 may implement perception (e.g., 3D object detection and map segmentation) and prediction (e.g., motion tracking) and may generate ego and agent tokenized scene representation.

Based upon these token inputs, neural trajectory planner 312 of adaptation module 330 utilizes learned and defined scene codebooks 310 and trajectory codebooks 311 to generate predicted trajectories 315. In particular, based upon the correlation between scene codes of the scene codebook 310 and the current scene from the scene tokenizer 220, a Bayesian model 316 (e.g., utilizing a Gaussian process (GP) 317) of the neural trajectory planner 312, in combination with the trajectory codebook 311, predicts a predicted trajectory 315. Therefore, in one embodiment, neural trajectory planner 312 is trained with the base model on source-domain data from the off-line source city to generate predicted trajectories 315 and to generate vector-quantized scene representations 335 that identify errors between the predicted trajectories 315 and the actual trajectory chosen in the source-domain data (e.g., by human driver). The predicted trajectories 315 and vector-quantized scene representations 335 are fed-back and utilized by the neural trajectory planner 312 and scene codebook 310 for training the neural trajectory planner 312 and scene codebook 310. It should be noted that, in some embodiments, in addition to token inputs being based upon image-based inputs from scene tokenizer 320 (e.g., image inputs 304 from cameras) that token inputs may be based on other sensor inputs such as position inputs from GPS sensors, radar inputs from RADAR sensors, LIDAR inputs from LIDAR sensors, visual depth mapping inputs, radio inputs from radio receivers for performing radio ranging, downloaded data inputs, etc.

Also, as will be described, when adapting on target-domain data, the adaptation module 330 provides the predicted trajectory to serve as either a pseudo ground-truth (GT) label (when GT is not available) or regularization in training (when GT is available). This allows for more stable adaptation for the motion planner 322. Adaptation module 330 also provides uncertainty measures to indicate a prediction confidence level for selecting more useful samples for training in domain adaptation for the motion planner 322.

In one embodiment, in the scene codebook 310, each set of basis tokens contain agent tokens and ego tokens, as previously described. These types of tokens are used to cross-attend to the birds-eye-view (BEV) and map features in the existing base E2E planning pipeline. These basis tokens may be learned during training on off-line source-domain data from the source city (e.g., to approximate a scene).

In particular, they are trained in a way so that they can best approximate the representation (in the base model) of any given scene. As to the trajectory codebook 311, in one embodiment, a set of trajectories are predefined, and grouped to different modes based on k-means and driving commands (e.g., left turns with different angles can be in the same mode, right turns, etc.). In one embodiment, every scene code (e.g., a set of agent/ego tokens) maps to one trajectory. In one example embodiment, in experimental testing, 7168 scene codes/trajectories (4096 for agents and 3072 for ego) were utilized. It should be noted that trajectories for agents (e.g., other cars) are also predicted when predicting the trajectory for the ego car.

In one embodiment, an example of methods to learn scene codes for the scene codebook 310 will be described. Learning scene codes for the scene codebook 310 may be initially based on source domain data. The base E2E network of the RoCA system 300 may be trained using ground-truth (GT) on source data, with established training procedures, e.g., supervision from GT and planning constraints. It should be noted that while the scene tokens from the base model go into the adaptation module 350, the base network does not receive any gradients through the adaptation module 350 in this stage. In particular, correlation is computed between the current scene representation and the set of scene codes from the scene codebook 310. Based on the correlation, in one embodiment, the learnable kernel function Bayesian model 316 of the neural trajectory planner 312 formulates joint distribution scene representation and the scene code book 310. Thus, the Bayesian model 316 of the neural trajectory planner 312 derives weighted sums of scene codes that are used to approximate the current scene. The difference (e.g., L2 loss) between the approximated scene representation, shown as the vector-quantized scene representation 335, and the actual scene representation from the base model, may be used to learn the set of scene codes for the scene codebook 310, as well as other parameters in the adaptation module 330. Based on these weights, the predicted trajectory 315 by the adaptation module 330 is a weighted sum of the basis trajectories. This type of prediction may be supervised by the following example features: 1) The same trajectory supervision that is applied to the base network output; 2) A classification loss that requires the predicted trajectory to be in the correct mode (e.g., left turns); 3) A contrastive loss that requires the predicted trajectory (e.g., left turn) to be similar to trajectories in the same mode (e.g., other left turns) and 4) different from those in other modes (e.g., right turns). It should be appreciated that these are just examples.

As to the correlation computation, in one embodiment, a multivariate Gaussian distribution can be used among all the possible scene representations. However, it should be appreciated that other distributions may be utilized. Further, in one embodiment, a Radial Basis Function (RBF) may be utilized, which is an exponential function, when calculating the distance between any pair of scene representations. However, it should be appreciated that other functions may be utilized. Additionally, other additional layers of multilayer perceptions (MLPs) may be used to encode the scene codes of the scene codebook 310 or trajectory codes of the trajectory codebook 311, such that there is learnability in the distance function. The output is a set of weights. A higher weight indicates that the corresponding scene code is more correlated/similar with the current given scene.

In one embodiment, more details regarding the multivariate Gaussian distribution will be described. Given a current scene f, the scene codes bᵢ, ∀i∈{1, . . . , N}, and a pairwise correlation function K, the predicted posterior mean of the current scene representation is μ_{f}=K(f,B)K(B,B)⁻¹B, where B=[b₁, . . . , b_{N}]. In one embodiment, μ_{f} is used as the predicted, vector-quantized scene representation 335 from the Bayesian adaptation module 330. For the trajectory prediction 315, the predicted mean trajectory is μ_{w}=\hat{K}(f,B)\hat{K}(B,B)⁻¹W, where W is the set of candidate trajectories [w₁, . . . , w_{N}]. It should be noted that \hat{K} uses the same kernel function, e.g., exponential, but applies different MLP layers to encode the trajectories.

As to adaptation on the target domain, in one embodiment, an example will be provided. For example, with reference to FIG. 3B, FIG. 3B can be utilized to describe on-line implementation for a target city, such that predicted trajectories 350 for on-line implementation for the target city are based on the developed adaptation module 330 from the off-line development based on source data from a source city (FIG. 3A).

FIG. 3B may be utilized to describe on-line implementation for a target city, such that predicted trajectories for on-line implementation for the target city are based on the developed adaptation module 330 from the off-line development based on source data from the source city (FIG. 3A). Therefore, FIG. 3B illustrates an example embodiment, where processor(s) (e.g., processor(s) 212) of the vehicle 302 may be configured to: obtain a scene codebook 310 to identify trajectories for one or more scenarios; and implement the neural trajectory planner 312 of the adaptation module 350 to predict a predicted trajectory 350 for the vehicle 302 in the on-line target-domain implementation conditioned on the current scenario of the vehicle 302 based on the scene codebook 310 of adaption module 330 to implement autonomous driving of the vehicle. As has been described, in one embodiment, the neural trajectory planner 312 may utilize a probabilistic Bayesian model 316, in which, the probabilistic Bayesian model 316 utilizes a Gaussian process (GP) 317. In one example embodiment, as has been described, the probabilistic Bayesian model 316 of the neural trajectory planner 312 determines a correlation between the current scenario of the vehicle 302 and a set of learned scene features of the scene codebook 310 to predict the predicted trajectory 350 in the on-line target domain for the vehicle 302 for implementation. In one embodiment, the scene codebook 310 may be obtained or received by vehicle 302 through a network interface (e.g., transceiver, modem, etc.) of the vehicle.

When training/finetuning on the target domain, the adaptation module 330 is not updated and only the base network 301 is updated. The adaptation module serves 330 as a teacher. For example, when no ground-truth (GT) trajectory label is provided, e.g., internet data, noisy position measurement, prediction by the adaptation module 330, e.g., predicted trajectory target 350, serves as the ground-truth label for supervised learning, which can be processed through the motion planner 322. Therefore, the GP process implemented by the neural trajectory planner 312 can fine-tune the motion planner 322. Classification loss and contrastive loss to the prediction by the base E2E network may be applied. It should be noted that the output is converted from the base network to a classification+regression format. When ground-truth trajectory label is provided, e.g., new data collected by a test vehicle, prediction by the adaptation module 330 serves as a training regularization. Additionally, in one embodiment, the adaptation module 330 can indicate uncertainty. For example, the difference between the vector-quantized scene representation 335 generated by the adaptation module 330 and the base network scene representation indicates uncertainty. A higher difference means that the current scene is more different from those in the source domain, such that, it is harder to be approximated by the learned scene codes. This uncertainty measure can be used to select a subset of useful/more uncertain data for fine-tuning the planning network (e.g., for more data-efficient training). Also, at inference time, this can indicate a confidence level/reliability of the planned trajectory.

Therefore, as previously described, adaptation module 330 can be used to supervise and/or regularize the training/finetuning when adapting a base E2E planning network to a target data domain. Specifically, adaptation module 330 includes scene codebook 310, which contains a finite number of groups of agent/ego tokens. These groups form a basis set to represent any scene. Each group of tokens maps to a defined trajectory, and there is a trajectory codebook 311 that has the same number of trajectories as the number of token groups. Based on correlation between the sets of tokens in the scene codebook 310 and the tokens of the current given scene, a vector-quantized representation of the scene 335 is computed based on the basis set by the neural trajectory planner 312. Based on the correlation, a trajectory 315 for the current given scene is predicted by combining the ones in the trajectory codebook. Different learn-abilities are introduced in the respective correlation functions for scene codes and trajectory codes (e.g., using the same will result in worse learning performance). As has been described, during source-domain training, the scene codebook 310 and adaptation parameters are learned. As has been described, during target-domain training, the base network is adapted by leveraging the adaptation module 330. In one embodiment, as has been described, neural trajectory planner 312 uses Gaussian process 317 to model the correlation structure among groups of scene-representing tokens. By using an exponential function as a distance measure between two groups of tokens, it is possible to use other distance measure function, as long as it's differentiable. Additionally, as has been described, deep learning layers can be used to process the output of the distance measure to make it learnable. Further, as has been described, an active learning scheme is utilized on the target domain. The adaptation module 330 provides an uncertainty measure on each given scene, via the difference between its vector-quantized representation 335 and the actual representation computed by the base model. A larger difference meaning the current scene is more different from the source domain data. This measure is utilized to find more uncertain/valuable training samples from the target domain, such that the model is fine-tuned in a more data-efficient way.

As shown in FIG. 3B, RoCA system 300 may be utilized for an on-line implementation for a target city, such that predicted trajectories for on-line implementation for the target city are based on the developed adaptation module 330 from the off-line development based on source data from the source city (FIG. 3A). As previously described, RoCA system 300 may: obtain a scene codebook 310 to identify trajectories for one or more scenarios; and implement a neural trajectory planner 312 to predict a trajectory 350 for the vehicle 302 conditioned on a current scenario of the vehicle 302 based on the scene codebook 310 to implement autonomous driving of the vehicle 302. As has been described, in one embodiment, the neural trajectory planner 312 may utilize a probabilistic Bayesian model 316, in which, the probabilistic Bayesian model 316 utilizes a Gaussian process (GP) 317. In one example, as previously described, the probabilistic Bayesian model 316 of the neural trajectory planner 312 determines a correlation between the current scenario of the vehicle 302 and a set of learned scene features of the scene codebook 310 to predict the trajectory 350 for the vehicle. The scene tokenizer 320 may be utilized to transform sensory inputs (e.g., from previous described sensor 230), such as, image inputs 340 from cameras from the vehicle 302 into a structured interpretable representation that are composed of “tokens” that represent objects, regions, or other relevant features in the scene. These tokens (e.g., ego tokens and agent tokens) operate as an input to the RoCA system 300, enabling the RoCA system 300 to comprehend and predict the driving environment for vehicle 302, as has been described. Based upon these token inputs, adaptation module 330 utilizes learned and defined scene codebooks 310 and trajectory codebooks 311. In particular, based on the correlation between scene codes of the scene codebook 310 and the current scene from the scene tokenizer 220, Bayesian model 316 (e.g., utilizing Gaussian process (GP) 317) of the neural trajectory planner 312 predicts a predicted trajectory 350 that is implemented via motion planner 322. Motion planner 322 computes the optimal path based upon the predicted trajectory from the adaptation module 330.

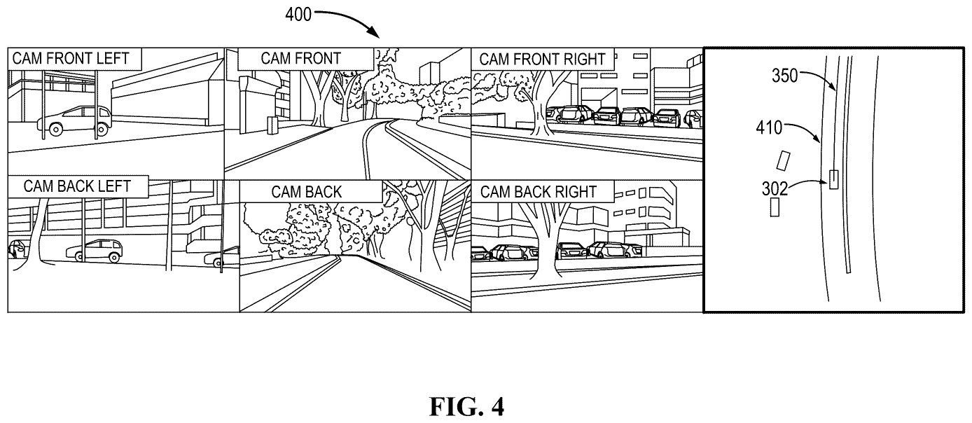

For example, with brief additional reference to FIG. 4, FIG. 4 illustrates camera images input 400 (cam front left, cam front, cam front right, cam back left, cam back, cam back right) from vehicle 302 that are utilized by scene tokenizer 320 to be structured into “tokens” that represent objects, regions, or other relevant features in the scene. These tokens (e.g., ego tokens and agent tokens) operate as an input to the RoCA system 300, enabling the RoCA system 300 to comprehend and predict the driving environment for vehicle 302 on road 410. Based upon these token inputs, adaptation module 330 utilizes learned and defined scene codebooks 310 and trajectory codebooks 311. In particular, based on the correlation between scene codes of the scene codebook 310 and the current scene from the scene tokenizer 220, Bayesian model 316 (e.g., utilizing a Gaussian process (GP) 317) of the neural trajectory planner 312 predicts a predicted trajectory 350 that is implemented via motion planner 322 for vehicle 302. In particular, a more efficient and optimal predicted trajectory 350 is selected. In one embodiment, a display device of the vehicle may be configured to display the predicted trajectory 350 for the vehicle 302.

As has been described, the RoCA system 300 provides an end-to-end autonomous driving framework that learns a representative scene codebook 310 during off-line source city training of ego and agent token embeddings and their corresponding mappings to waypoint trajectories. Further, as has been described, in one embodiment, the RoCA system 300 formulates trajectory predictions 315 based upon a Gaussian Process (GP) 317 in the neural trajectory planner 312 that is conditioned on the scene codebook 310 codebook and current scene embeddings. The GP's variance prediction enables uncertainty-aware loss weighting, promoting robustness and equal importance for long-tail scenarios during training. The RoCA system 300 is versatile, demonstrating strong performance in cross-domain generalization and supporting extensions for fine-tuning, active learning, and test-time adaptation. Empirically, the RoCA system 300 reduces the L2 trajectory error, collision rate, and long-tail trajectory error compared to baseline vision planners, achieving state-of-the-art results on the nuScenes planning benchmark.

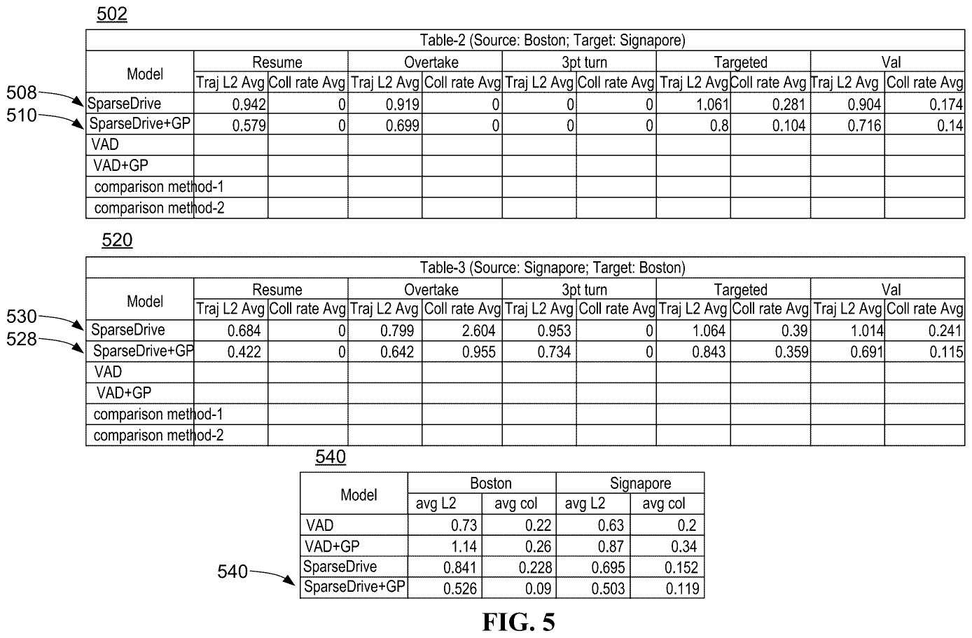

With additional reference to FIG. 5, sample test results are shown for the RoCA system 300 for autonomous driving. In a typical test for autonomous driving, source data refers to the data used to train a model off-line from a source city and target data refers to the data on which the model is tested or deployed on-line in a target city, which may have a different data distribution or characteristics. Basically, the sample testing is performed to identify whether the model trained on one set of driving conditions off-line (source city) perform well in a different set of conditions on-line during a real driving condition (target city).

As has been described, in one embodiment, the RoCA system 300 utilizing the adaption module 330 formulates trajectory predictions 315 based upon a Bayesian Model 316 utilizing a Gaussian Process (GP) 317 in the neural trajectory planner 312 that is conditioned on the scene codebook 310 and current scene embeddings and the GP's variance prediction enables uncertainty-aware loss weighting, promoting robustness and equal importance for long-tail scenarios during training and demonstrates strong performance in cross-domain generalization and supports extensions for fine-tuning, active learning, and test-time adaptation.

As illustrated in FIG. 5, test results were accumulated for the RoCA system 300, in which, source domain data was collected for the city of Boston and target domain data was the collected for the city of Singapore to test the usage of the adaption module 330 of RoCA system 300. This was also done in reverse-source domain data (Singapore) and target domain data (Boston). Metrics collected are for L2 trajectory error and collision rate. Lower numbers for L2 trajectory error and collision rate being better. Based on the results shown in FIG. 5, illustrating the test results, the RoCA system 300 significantly improved over the base model (e.g., SparseDrive—End-to-End Autonomous Driving via Sparce Scene Representation) and significantly outperformed existing state-of-the-art domain adaptation (e.g., VLP (Vision Language Planning Autonomous Driving)).

As shown in the Table 502, where the source data city is Boston and the target data city is Singapore, the RoCA system identified as SparseDrive+GP 510 has lower L2 trajectory errors and collision rates across every situation (Resume, Overtake, 3 pt turn, Targeted, Val) than the baseline model Sparse 508.

Similarly, as shown in the Table 520, where the source data city is Singapore and the target data city is Boston, the RoCA system identified as SparseDrive+GP 528 has lower L2 trajectory errors and collision rates across every situation (Resume, Overtake, 3 pt turn, Targeted, Val) than the baseline model Sparse 530.

Moreover, as shown in the Bottom Table 540, for average L2 and average collision for both cities Boston and Singapore, the RoCA system identified as SparseDrive+GP 545 under the VAD (Vectorized Scene Representation for Efficient Autonomous Driving) Evaluation Protocol has lower test results than VLP+VAD, VLP+UniAD, and SparseDrive.

Therefore, empirically, the RoCA system 300 reduces the L2 trajectory error, collision rate, and long-tail trajectory errors compared to baseline vision planners, achieving state-of-the-art results on the nuScenes planning benchmark. These previously described solutions provide an elegant and efficient way to adapt any end-to-end planning transformer of autonomous driving to any condition or any city, which is a fundamental problem to solve for autonomous driving. Additionally, this framework identifies the out-of-distribution samples in unknown data. This allows planning transformer not to hallucinate on out-of-distribution samples.

Additional examples of aspects will further be described.

As has been described, there are existing prior implementations of end-to-end autonomous driving but they involve problems with effective long-tail handling and prohibitive costs associated with massive pre-trained models. The RoCA system 300 is an end-to-end autonomous driving framework designed for efficient adaptation and enhanced robustness using multi-view images. Instead of relying on pre-trained LLMs, the RoCA system 300 learns a compact yet comprehensive scene codebook 310 containing basis token embeddings embeddings (b) that represent diverse ego and agent states, spanning both source and potentially target data characteristics. In one embodiment, the RoCA system 300 leverages this learned codebook within a Gaussian Process (GP) framework 317 implemented by the neural trajectory planner 312. During inference, given a new scene's token embedding, the GP probabilistically predicts future ego waypoints and agent motion trajectories by reasoning about the relationship between the current embedding and the learned basis embeddings (b) and their associated known trajectories (w=g(b)) for a learned mapping (g(.)). This probabilistic formulation inherently supports generalization, as predictions for novel scenes are informed by their similarity to known embeddings within the diverse scene codebook 310. Furthermore, the variance estimated by the GP 317 provides a principled measure of prediction uncertainty. This variance can be used to dynamically weight the training loss, enabling RoCA to automatically assign greater importance to uncertain or difficult predictions, thereby effectively addressing the training imbalance towards common scenarios and improving performance on critical long-tail events. In one embodiment, the RoCA system 300 typically involves an initial stage to build the codebook and optimize GP parameters using source data, followed by efficient deployment or adaptation using multi-view images processed through the learned GP component 317 of the neural trajectory planner 312. This architecture also naturally lends itself to extensions for online streaming adaptation and active learning strategies.

As has been described, the RoCA system 300 provides an end-to-end autonomous driving framework that learns a representative scene codebook 310 of ego and agent token embeddings and their corresponding mappings to waypoint trajectories. Further, in one embodiment, the RoCA system 300 formulates trajectory predictions 315 based upon a Gaussian Process (GP) 317 in the neural trajectory planner 312 that is conditioned on the scene codebook 310 codebook and current scene embeddings. The GP's variance prediction enables uncertainty-aware loss weighting, promoting robustness and equal importance for long-tail scenarios during training. The RoCA system 300 is versatile, demonstrating strong performance in cross-domain generalization and supporting extensions for fine-tuning, active learning, and test-time adaptation. Empirically, the RoCA system 300 reduces the L2 trajectory error, collision rate, and long-tail trajectory error compared to baseline vision planners, achieving state-of-the-art results on an nuScenes planning benchmark, as previously described.

### RoCA System

As has been described, the RoCA system 300 provides a framework for end-to-end autonomous driving. Given a sequence of multi-view 304 images, the overall objective is to predict the future trajectory 350 of the ego vehicle 302 about the scene. An overview of RoCA is shown in FIGS. 3A and 3B. As has been described, in one embodiment, the RoCA system 300 includes two main components: 1) the vision-based planner transformer 322 and a scene codebook 310 implemented with a neural trajectory planner 312 implementing a Gaussian process (GP) 317.

### RoCA Base Planning Model

Vision-based end-to-end planners commonly integrate perception, mapping, motion prediction, and planning within a multi-task framework. These typically consist of a scene encoder generating structured latent representations and a planning transformer predicting waypoints. These latent representations may be referred to as scene token embeddings. In one embodiment, the RoCA system 300 utilizes the traditional vision-based component primarily as a motion planner 322. Motion planner 322 takes ego and agent token embeddings—which encapsulate information cross-attended with BEV and map features—as input to predict both future ego waypoints and agent motion trajectories. Motion planner 322 serves a dual function within RoCA system 300, in that, it acts as the primary network for efficient, fast planning predictions at test time, while its scene encoder (e.g., scene tokenizer 320) simultaneously provides the crucial, highly structured scene token embeddings as input to the GP processor module of the neural trajectory planner 312.

As to set-up,

$$Let 𝒮 = {\{ {I}_{i}^{𝒮} \}}_{i = 1}^{{N}_{𝒮}} , 𝒯 = {\{ {I}_{i}^{𝒯} \}}_{i = 1}^{{N}_{𝒯}}$$

denote the sets of multi-view images 304 from the source and target domains, respectively. The RoCA system 300 includes three main learnable components: A scene encoder (e.g., scene tokenizer 320) functioning as a tokenizer, denoted by st(.; θₛₜ); a deterministic motion planner module 322, denoted by h (.; θₕ); and a Gaussian Process (GP) module 317 implemented by neural trajectory planner 312, denoted by g(.; θ_{g}, κ) where κ(.) represents the GP kernel function and θ_{g} learnable parameters of GP.

Given a set of multi-view images 304, I corresponding to a specific scene instance, it is first processed by the scene encoder 320 st(.). Within this encoder, initial feature extraction is followed by a cross-attention mechanism between preliminary ego/agent token embeddings and BEV/map query embeddings. We denote the final, context-aware output token embeddings from the scene encoder st(I; θₛₜ), ego and agent token embeddings as, (e) and (a), respectively. These resultant ego (e) and agent (a) token embeddings, serve as input to two parallel pathways for trajectory prediction:
1. The deterministic motion planner module 322 takes these embeddings as input and predicts the future ego waypoint trajectory p_{pred}, c_{pred}=h(e, a; θₕ) and agent motion trajectories m_{a,pred}, c_{a,pred}=h(e, a; θₕ)
2. Concurrently, the GP module 317 of neural trajectory planner 312 also takes e and a as input, leveraging its internal code-book and kernel function x, to predict the corresponding future ego waypoints p_{w}, c_{w}=g_{ego}(e, a; θ_{g}, κ) and agent motion trajectories m_{a,w}, C_{a,w}=g_{agent}(e, a; θ_{g}, κ) agent.

Both the motion planner 322 and the neural trajectory planner 312 utilizing the GP module 317 predict trajectories using an anchor-based approach. For both ego waypoints and agent motions, the respective module first classifies the intended trajectory into one of the predefined groups (N_{ego} (for ego) or N_{agent} (for agent)), and then predicts a residual offset. The final predicted trajectory (p_{pred}, m_{a,pred}, p_{w}, m_{a,w}) is constructed by summing the anchor trajectory corresponding to the classified group (c_{pred}, c_{a,pred}, c_{w}, C_{a,w}) with the predicted residual.

### Scene Codebook

As has been described, the scene codebook 310 is constructed and designed to learn a set of basis embeddings, as an example:

$$ℬ = {\{ {B}_{k} = {\{ {b}_{j , k} \}}_{j = 1}^{C} \}}_{k = 1}^{{N}_{code}} ,$$

capable of comprehensively representing the diverse ego (e) and agent (a) token embeddings encountered across various driving scenes. The primary objective within the RoCA framework 300 is for these basis embeddings to effectively map to distinct categories of plausible and safe driving trajectories. To establish this structure, the scene codebook's 310 organization is initialized based on trajectory characteristics. As an example, sampling is begun with a large pool of N_{code}*C representative trajectories, denoted collectively as W, from datasets exhibiting safe human driving behavior. These trajectories are then clustered into N_{code} distinct groups, {Wₖ}^{Ncode,k=1}, such that each group Wₖ contains C trajectories sharing similar driving patterns. For all our experiments, the group size is set to C=64. Each trajectory group w_{j,k}∈Wₖ is then conceptually associated with a unique, learnable basis embedding b_{j,k}∈Bₖ within the codebook B. The allocation of these groups is purpose-driven: designate N_{ego} groups to represent distinct ego vehicle waypoint patterns (specifically, 16 groups for each driving command: “turn left”, “turn right”, and “go straight”), and N_{agent} (=64) groups to represent various types of agent motion trajectories. This results in a total codebook size of N_{code}=N_{ego}+N_{agent}=112 basis embeddings.

### Gaussian Process

Further, to learn the basis embedding:

$$ℬ = {\{ {B}_{k} = {\{ {b}_{j , k} \}}_{j = 1}^{C} \}}_{k = 1}^{{N}_{code}} ,$$

within the scene codebook 310 is a crucial step in the RoCA framework 300. In one embodiment, the goal is to ensure these basis embeddings effectively capture the manifold of representative ego (e) and agent (a) token embeddings encountered across diverse scenes. Given the context-aware ego (e) and agent (a) token embeddings for a specific scene, each embedding is first associated with its most relevant basis embedding(s) in the scene codebook 310. This involves classifying the current embedding e (and similarly for each a) into one of the N_{ego} groups represented by the basis embeddings Bₖ. Let cₑ denote the index of the class/group assigned to e. This classification is performed based on kernel distance metric and, potentially an MLP operating on distances: cₑ=MLP(κ(e, B)). Let B_{ce} represent the basis embeddings corresponding to the assigned class cₑ. The core mechanism for learning the basis B_{ce} involves reconstructing the original embedding e using its associated basis embedding via the Gaussian Process (GP) formulation 317. The joint relationship is modeled between e and B_{ce} using the GP kernel K. Assuming a standard GP prior (e.g., zero mean), the conditional distribution of e given B_{ce} yields a predictive mean \hat{ }e (the reconstruction) and a predictive variance de:

$$p ( e , \text{?} ) = 𝒩 ( [ \begin{matrix}\hat{e} \\ \text{?}\end{matrix} ] \cdot [ \begin{matrix}κ ( e ) & κ ( e , \text{?} ) \\ {κ ( e , \text{?} )}^{T} & κ ( \text{?} )\end{matrix} ] ) ;$$

$$\hat{e} = \text{?} + κ ( e , \text{?} ) {κ ( \text{?} )}^{- 1} \text{?} ; \text{?} = κ ( e ) - κ ( e , \text{?} ) {κ ( \text{?} )}^{- 1} {κ ( e , \text{?} )}^{T} + {σ}_{noise} 𝕀$$

$$\text{?} \text{indicates text missing or illegible when filed}$$

Here, p(.) denotes probability density function, κ(.,.) denotes the kernel function evaluation between embeddings, and σₙₒᵢₛₑ represents a small, potentially learnable, noise variance term. This prediction ê serves as an approximation of the original embedding e, reconstructed using information encoded in the codebook basis B_{ce}. This reconstruction process is supervised by minimizing the discrepancy between the original embeddings and their GP-based reconstructions. Applying the same reconstruction process to obtain approximations â and variances σₑ for each agent embedding a (using their respective associated basis embeddings B_{c}_{ₐ}, the approximation loss is defined Lₐₚₚᵣₒₓ:

$${ℒ}_{approx} = \frac{1}{{σ}_{e}^{2}} {\vert \hat{e} - e \vert}^{2} - log ( {σ}_{e} ) + \frac{1}{{σ}_{a}^{2}} {\vert \hat{a} - a \vert}^{2} - log ( {σ}_{a} ) + {‖ {BB}^{T} - 𝕀 ‖}^{2}$$

Crucially, this loss Lₐₚₚᵣₒₓ drives the learning of the scene codebook 310 basis embeddings B, as the reconstructions ê and σₑ (and their variances) are directly computed using B and the kernel function κ. To ensure B learns to effectively represent the distribution of input embeddings, the original embeddings e and a are treated as fixed targets (i.e., their gradients are detached) when computing this loss. Additionally, the class labels cₑ (ego), cₐ (agent) are supervised using corresponding ground-truth class labels, which will be further described. Note the basis embedding B_{c} are associated with corresponding trajectories W_{c} using one-to-one mapping, i.e. ∀w∈W_{c}, ∃b∈B_{c} such that w=g(b).

### Trajectory Prediction

The primary objective of the RoCA system framework 300 is to accurately predict future ego waypoint trajectories and agent motion trajectories, leveraging the learned scene codebook 310 B for robust generalization. Given the context-aware ego (e) and agent (a) token embeddings derived from the scene encoder 320, the Gaussian Process (GP) module 317 provides a probabilistic prediction pathway. Similar to the basis learning step, the current embeddings are first associated with relevant groups in the scene codebook 310. For the ego embedding e, we predict classification logits c_{e,w} over the N_{ego} groups, potentially using the kernel similarity or an MLP: c_{e,w}=MLP(κ(e, B)) to denote the index of the most likely group assigned to e. A similar classification yields c_{a,w} for agent embeddings a. The GP module 317 then predicts the trajectory (or trajectory residual) corresponding to the input embedding e by conditioning on the learned relationship between the scene codebook 310 basis embeddings B_{c}_{_{e,w}} and their associated target trajectories W_{c}_{_{e,w}}. Using the standard GP regression formulation with kernel K, the predicted mean trajectory p\hat{ }_{w} and predictive variance σ_{w} for the ego vehicle are computed as:

$$p ( h ( e ) , g ( \text{?} ) ) = 𝒩 ( [ \begin{matrix}\hat{{p}_{w}} \\ g ( \text{?} )\end{matrix} ] \cdot [ \begin{matrix}κ ( e ) & κ ( e , \text{?} ) \\ {κ ( e , \text{?} )}^{T} & κ ( \text{?} )\end{matrix} ] ) ;$$

$$\hat{{p}_{w}} = \text{?} + κ ( e , \text{?} ) {κ ( \text{?} )}^{- 1} \text{?}$$

$${σ}_{w}^{2} = κ ( e ) - κ ( e , \text{?} ) {κ ( \text{?} )}^{- 1} {κ ( e , \text{?} )}^{T} + {σ}_{noise} 𝕀$$

$$\text{?} \text{indicates text missing or illegible when filed}$$

Here p(.) denotes probability function. This way-point prediction p\hat{ }_{w} along with its uncertainty σ² plays an important role in performing the cross-domain learning framework of RoCA.

For example, as previously described with reference to FIG. 3B, processor(s) (e.g., processor(s) 212) of the vehicle 302 may be configured to: obtain a scene codebook 310 to identify trajectories for one or more scenarios; and implement a neural trajectory planner 312 to predict a trajectory 350 for the vehicle 302 conditioned on a current scenario of the vehicle 302 based on the scene codebook 310 to implement autonomous driving of the vehicle. In previously described embodiments, the neural trajectory planner 312 may utilize a probabilistic Bayesian model 316, in which, the probabilistic Bayesian model 316 utilizes a Gaussian process (GP) 317, and, the probabilistic Bayesian model 316 of the neural trajectory planner 312 determines a correlation between the current scenario of the vehicle 302 and a set of learned scene features of the scene codebook 310 to predict the trajectory 350 for the vehicle 302.

As previously described with reference to FIG. 5, various experiments were conducted using two vision-based end-to-end planners (SparseDrive and VAD) due to their performance, efficiency, and ability to model the interaction between scene components. NuScenes datasets were used for the task of open-loop planning. This dataset consisted of 28k total samples in a 22k/6k training/validation split. The objects in each scene were annotated with 3D bounding box, orientation, and vehicle speed information. Planning performance was evaluated based on the predicted future trajectories of the ego vehicle 3 seconds into the future, where 2 waypoints are predicted per second. Two metrics, the L2 error (in meters) between the predicted and ground-truth waypoints as well as the collision rate (in %) between the ego-vehicle and the surrounding vehicles, were used. As previously described, the testing illustrated, empirically, the RoCA system 300 reduces the L2 trajectory error, collision rate, and long-tail trajectory errors compared to baseline vision planners, achieving state-of-the-art results on the nuScenes planning benchmark. These previously described solutions provide an elegant and efficient way to adapt any end-to-end planning transformer of autonomous driving to any condition or any city, which is a fundamental problem to solve for autonomous driving.

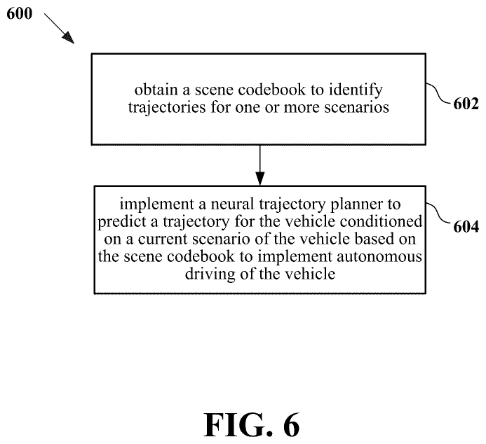

With brief reference to FIG. 6, a flowchart of the previously described method to implement autonomous driving by a vehicle according to one aspect will be described. At block 602, method 600 obtains a scene codebook to identify trajectories for one or more scenarios. At block 604, method 600 implements a neural trajectory planner to predict a trajectory for the vehicle conditioned on a current scenario of the vehicle based on the scene codebook to implement autonomous driving of the vehicle.

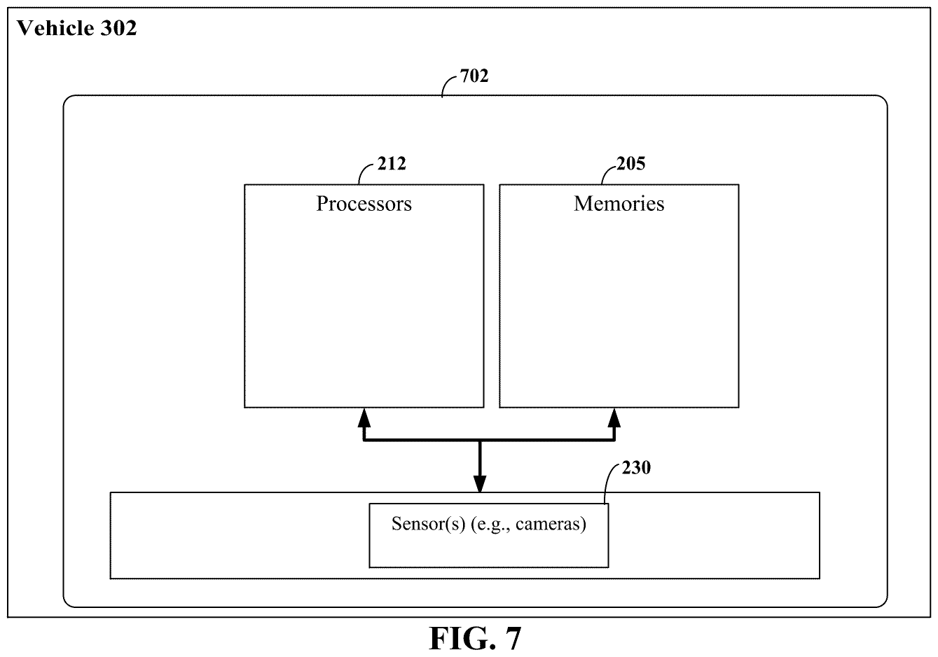

With additional reference to FIG. 7, FIG. 7 provides a simplified diagram of circuitry 702 to implement the previously described processes of FIGS. 1-6. For example, as previously described with reference to FIG. 3B, vehicle 302 may be useable in autonomous driving and may comprise one or more memories 205 to store one or more images 304 and one or more processor(s) 212 coupled to the one or more memories 205. The one or more of processor(s) 212 may be configured to: obtain a scene codebook 310 to identify trajectories for one or more scenarios; and implement a neural trajectory planner 312 to predict a trajectory 350 for the vehicle 302 conditioned on a current scenario of the vehicle 302 based on the scene codebook 310 to implement autonomous driving of the vehicle. Further, as previously described, in one embodiment, the neural trajectory planner 312 may utilize a probabilistic Bayesian model 316, in which, the probabilistic Bayesian model 316 utilizes a Gaussian process (GP) 317. Furthermore, as previously described, the probabilistic Bayesian model 316 of the neural trajectory planner 312 determines a correlation between the current scenario of the vehicle 302 and a set of learned scene features of the scene codebook 310 to predict the trajectory 350 for the vehicle 302.

In one embodiment, the one or more of processor(s) 212 may be configured to: receive input sensor data including image frames (e.g. from sensors (e.g., cameras)) 230 during end-to-end autonomous driving; and continuously update the scene codebook 310 based upon the received input sensor data including the image frames to identify trajectories for or more scenarios.

It should be appreciated that this is just one example of a vehicle 320 utilizing the previously described circuitry, processors, components, machine-learning (ML), models, modules, neural networks, artificial intelligence (AI), codebooks, functions, etc. (e.g., FIGS. 1-7) to implement end-to-end autonomous driving and that other suitable implementations may be utilized.

As has been described, aspects of the disclosure relate to a robust cross-domain end-to-end autonomous driving (RoCA). In the RoCA system, an E2E framework using multi-view images is utilized. In one embodiment, as previously described, the RoCA system learns a compact scene codebook of representative ego and agent token embeddings spanning diverse driving conditions. In one embodiment, a Gaussian Process (GP) framework of a probabilistic Bayesian model, conditioned on this codebook, is utilized to probabilistically predict future trajectories. In particular, the GP's predicted variance provides uncertainty estimation, enabling an adaptive loss weighting scheme that prioritizes challenging long-tail scenarios during training. This approach enhances both domain generalization and long-tail robustness without relying on massive pre-trained models. The RoCA system, reduces L2 trajectory error, collision rate, and long-tail trajectory error compared to vision-based baselines, achieving state-of-the-art performance on planning benchmarks and supports versatile adaptation settings.

Various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limitations.

The various illustrative logical blocks, modules, and circuits described in connection with the aspects disclosed herein may be implemented or performed with a general purpose processor, a central processing unit (CPU), a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be appreciated that processor(s) utilized may include central processing unit(s) (CPU(s)) or a multi-core CPU configured for learning in accordance with aspects of the present disclosure. Variables (e.g., neural signals, weights), system parameters associated with a computational device (e.g., neural network with weights), delays, frequency bin information, and task information may be stored in memory blocks and associated with neural processing units (NPUs), in memory blocks associated with CPU(s), in memory blocks associated with tensor processing units (TPUs), in memory blocks associated with graphics processing units (GPUs), in memory blocks associated with digital signal processors (DSPs), in general memory blocks, or may be distributed across multiple blocks. Instructions executed at a CPU may be loaded from a program memory associated with the CPU or may be loaded from a memory block. As examples, various AI accelerators, such as, GPUs, NPUs, DSPs, TPUs may be utilized with processor(s) (e.g., a CPU) to aid in implementing the previously described machine-learning (ML), models, modules, neural networks, artificial intelligence (AI), codebooks, functions, etc. (e.g., FIGS. 1-7) to implement end-to-end autonomous driving and that other suitable implementations may be utilized.

Various modifications to the described aspects may be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The processes previously described may include additional aspects, such as any single aspect or any combination of aspects described below and/or in connection with one or more other processes described elsewhere herein.
Aspect 1: An apparatus for a vehicle useable in autonomous driving comprising: one or more memories configured to store one or more images; and one or more processors coupled to the one or memories, the one or more processors configured to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle.
Aspect 2: The apparatus of aspect 1, wherein the neural trajectory planner comprises a probabilistic Bayesian model.
Aspect 3: The apparatus of aspect 2, wherein the probabilistic Bayesian model utilizes a Gaussian process (GP).
Aspect 4: The apparatus of any of aspects 2 through 3, wherein, the probabilistic Bayesian model of the neural trajectory planner determines a correlation between the current scenario of the vehicle and a set of learned scene features of the scene codebook to predict the trajectory for the vehicle.
Aspect 5: The apparatus of any of aspects 1 through 4, wherein, the scene codebook is generated by the neural trajectory planner.
Aspect 6: The apparatus of any of aspects 1 through 5, wherein, the scene codebook comprises ego tokens and agent tokens.
Aspect 7: The apparatus of any of aspects 1 through 6, wherein, the scene codebook includes a plurality of basis tokens that are learned during training on source-domain data to approximate a scene.
Aspect 8: The apparatus of any of aspects 1 through 7, wherein, the neural trajectory planner further comprises a trajectory codebook.
Aspect 9: The apparatus of aspect 8, wherein, the neural trajectory planner determines a correlation between tokens of the current scenario of the vehicle and tokens of the scene codebook, and based on the correlation, in combination with the trajectory codebook, a trajectory for the vehicle is predicted.
Aspect 10: The apparatus of any of aspects 8 through 9, wherein, the tokens of the current scenario of the vehicle are based upon a plurality of images and other sensor inputs from the vehicle.
Aspect 11: The apparatus of any of aspects 9 through 10, wherein, the neural trajectory planner further provides a confidence level of the predicted trajectory based on the correlation.
Aspect 12: The apparatus of any of aspects 1 through 11, further comprising: one or more cameras configured to capture images used to generate the tokens of the current scenario.
Aspect 13: The apparatus of any of aspects 1 through 12, further comprising: a display device configured to display the predicted trajectory for the vehicle.
Aspect 14: The apparatus of any of aspects 1 through 13, further comprising: a modem configured to receive the scene codebook.
Aspect 15: An apparatus for a vehicle useable in autonomous driving comprising: one or more memories configured to store one or more images; and one or more processors coupled to the one or memories, the one or more processors configured to: receive input sensor data including images during end-to-end autonomous driving; and continuously update a scene codebook based upon the received input sensor data including images to identify trajectories for one or more scenarios.
Aspect 16: The apparatus of aspect 15, wherein the one or more processors are further configured to: implement a neural trajectory planner to predict a trajectory for the vehicle conditioned on a current scenario of the vehicle based on the scene codebook to implement end-to-end autonomous driving of the vehicle.
Aspect 17: The apparatus of aspect 16, wherein the neural trajectory planner comprises a probabilistic Bayesian model.
Aspect 18: The apparatus of aspect 17, wherein the probabilistic Bayesian model utilizes a Gaussian process (GP).
Aspect 19: The apparatus of any of aspects 17 through 18, wherein, the probabilistic Bayesian model of the neural trajectory planner determines a correlation between the current scenario of the vehicle and a set of learned scene features of the scene codebook to predict the trajectory for the vehicle.
Aspect 20: A non-transitory computer-readable data storage medium having stored thereon instructions that, when executed, cause one or more processors to: obtain a scene codebook to identify trajectories for one or more scenarios; and implement a neural trajectory planner to predict a trajectory for the vehicle conditioned on a current scenario of the vehicle based on the scene codebook to implement autonomous driving of the vehicle.

This disclosure describes one or more examples that may be applied independently or in a combined way. It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Various examples have been described. These and other examples are within the scope of the following claims.

What is claimed is:

1. An apparatus for a vehicle useable in autonomous driving comprising:
one or more memories configured to store one or more images; and
one or more processors coupled to the one or memories, the one or more processors configured to:
obtain a scene codebook to identify trajectories for one or more scenarios; and
implement a neural trajectory planner to predict a trajectory for the vehicle conditioned on a current scenario of the vehicle based on the scene codebook to implement autonomous driving of the vehicle.

2. The apparatus of claim 1, wherein the neural trajectory planner comprises a probabilistic Bayesian model.

3. The apparatus of claim 2, wherein the probabilistic Bayesian model utilizes a Gaussian process (GP).

4. The apparatus of claim 2, wherein, the probabilistic Bayesian model of the neural trajectory planner determines a correlation between the current scenario of the vehicle and a set of learned scene features of the scene codebook to predict the trajectory for the vehicle.

5. The apparatus of claim 1, wherein, the scene codebook is generated by the neural trajectory planner.

6. The apparatus of claim 5, wherein, the scene codebook comprises ego tokens and agent tokens.

7. The apparatus of claim 5, wherein, the scene codebook includes a plurality of basis tokens that are learned during training on source-domain data to approximate a scene.

8. The apparatus of claim 7, wherein, the neural trajectory planner further comprises a trajectory codebook.

9. The apparatus of claim 8, wherein, the neural trajectory planner determines a correlation between tokens of the current scenario of the vehicle and tokens of the scene codebook, and based on the correlation, in combination with the trajectory codebook, a trajectory for the vehicle is predicted.

10. The apparatus of claim 9, wherein, the tokens of the current scenario of the vehicle are based upon a plurality of images and other sensor inputs from the vehicle.

11. The apparatus of claim 9, wherein, the neural trajectory planner further provides a confidence level of the predicted trajectory based on the correlation.

12. The apparatus of claim 1, further comprising: one or more cameras configured to capture images used to generate the tokens of the current scenario.

13. The apparatus of claim 1, further comprising: a display device configured to display the predicted trajectory for the vehicle.

14. The apparatus of claim 1, further comprising: a modem configured to receive the scene codebook.

15. An apparatus for a vehicle useable in autonomous driving comprising:
one or more memories configured to store one or more images; and
one or more processors coupled to the one or memories, the one or more processors configured to:
receive input sensor data including images during end-to-end autonomous driving; and
continuously update a scene codebook based upon the received input sensor data including images to identify trajectories for one or more scenarios.

16. The apparatus of claim 15, wherein the one or more processors are further configured to: implement a neural trajectory planner to predict a trajectory for the vehicle conditioned on a current scenario of the vehicle based on the scene codebook to implement end-to-end autonomous driving of the vehicle.

17. The apparatus of claim 16, wherein the neural trajectory planner comprises a probabilistic Bayesian model.

18. The apparatus of claim 17, wherein the probabilistic Bayesian model utilizes a Gaussian process (GP).

19. The apparatus of claim 17, wherein, the probabilistic Bayesian model of the neural trajectory planner determines a correlation between the current scenario of the vehicle and a set of learned scene features of the scene codebook to predict the trajectory for the vehicle.

20. A non-transitory computer-readable data storage medium having stored thereon instructions that, when executed, cause one or more processors to:
obtain a scene codebook to identify trajectories for one or more scenarios; and
implement a neural trajectory planner to predict a trajectory for a vehicle conditioned on a current scenario of the vehicle based on the scene codebook to implement autonomous driving of the vehicle.
